(19) United States
(12) Patent Application Publication
(10) Pub. No.: US 2011/0026856 A1
(43) Pub. Date: Feb. 3, 2011

(54) Bag, Bag Pack, and Methods and Compositions for Making and Dispensing Thereof

(76) Inventor: Erick Erardo Lopez-Araiza, Carrollton, TX (US)

Correspondence Address: VINSON & ELKINS L.L.P., First City Tower, 1001 Fannin Street, Suite 2300, HOUSTON, TX, 77002-6760, US

(21) Appl. No.: 12/511,240

(22) Filed: Jul. 29, 2009

(51) Int. Cl. B65D 33/08; B65D 33/00; B65D 83/00; B26D 1/00

(52) U.S. Cl. 383/10; 383/32; 221/45; 83/697

(57) ABSTRACT

A bag is disclosed having handle portions with mounting apertures and a central mounting tab having a central mounting aperture. The central mounting aperture is formed as a generally inverted “V” or triangular shaped slot with inwardly and upwardly curved lower portions. A bag pack is also disclosed formed of multiple stacked handle bags having aligned mounting apertures defined through the handle portions of the bags for reception of mounting rods therethrough. The mounting apertures are formed as elongated, generally vertically extending, slots having curved upper and lower portions. Elongated mounting slots make possible the use of shorter handles for the bags without sacrificing either the size of the mouth opening during loading or the carrying capacity of the bags. The central mounting tab on the multiple stacked bags has a vertical aperture between the central mounting aperture and the bag mouth, thus permitting the bag to be removed from a cooperating bag rack without leaving any portion of the central mounting tab on the bag rack.

### CROSS-REFERENCE TO RELATED APPLICATION

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present disclosure relates to thermoplastic bags, for example shopping bags, a unit or bag pack comprising multiple bags, a die for making such bags, and a mounting rack for dispensing such bags.

2. Description of the Related Art

Plastic bags, such as those typically found in retain stores and grocery markets, are generally formed from flattened tube portions selectively severed from a length of tubing of appropriate material and subsequently heat sealed along the lower and upper edges. An appropriate mouth-defining U-shaped cutout is normally made through the sealed upper edge, this cutout simultaneously defining both the upper mouth of the bag and a pair of laterally spaced handles. Such bags can be formed with or without side gussets.

It has become increasingly common to provide such bags in packs for suspension on racks with the individual bags separately dispensed therefrom. For such purposes, mounting apertures are formed in the handle portions of such bags as shown, for example, in U.S. Pat. Nos. 4,676,378 and Re. 33,264. In such bags the mounting apertures are formed as small round holes having a diameter not substantially larger than that of the mounting rods of the cooperating racks. When such bags are disposed in a mouth open position on the rods of the mounting rack (see, for example, FIGS. 2 and 10 of U.S. Pat. No. 4,676,378), the mounting apertures of the front and rear handles of the bag are displaced from each other as far as possible, with the length of displacement being limited by the maximum opening width of the bag and the length of the joined handle portions of the bags above the mounting apertures. This requires that the prior art bags have relatively elongated handle portions above the mounting apertures since, otherwise, it would not be possible to open the bag mouth to the extent required for filling.

Another problem with currently available bags is the presence of cut-outs, which result in a portion of the bag being left on the bag dispensing rack and/or in the area around the bag dispensing rack. Such loose cut-outs or scrap can be hazardous, for example causing a potential choking hazard in small children, or a slipping hazard by making the area around the bag dispenser slick with loose plastic cut-outs.

### BRIEF SUMMARY OF THE INVENTION

The present disclosure overcomes these and other shortcomings present in the art by providing improved bags and bag packs that are easier to open and manipulate, and do not leave any scrap on the dispensing rack or the area around the dispensing rack. In addition, the present disclosure provides bag cutting dies used to produce the improved bags and bag packs.

In one embodiment, the present disclosure provides a bag comprising a front bag wall comprising a top portion, a bottom portion, and first and second sides, and a rear bag wall comprising a top portion, a bottom portion, and first and second sides, the rear bag wall and the front bag wall connected at the first sides of the rear bag wall and the front bag wall and the second sides of the rear bag wall and the front bag wall, sealed at the bottom portions of the rear bag wall and the front bag wall and at the top portions of the rear bag wall and the top bag wall, the top portions of the rear bag wall and the front bag wall comprising a pair of laterally spaced handles, the handles comprising integral extensions of the rear and front bag walls, each of the handles comprising a mounting aperture, and a cold pin bonding site above the mounting aperture, the front wall and rear wall between the handles defining an open bag mouth, the handles extending above the bag mouth from a lower handle portion defining the lateral extent of a lower portion of the bag mouth to an upper handle portion defining a hand grip, a central mounting tab extending upwardly from the lower portion of the open bag mouth comprising a central mounting aperture and a first and a second pressure pin bonding region, each of the first and second pressure pin bonding regions comprising at least three pressure pin bonding sites, the first and second pin bonding regions located generally above and on opposite sides of the central mounting aperture, and a central severance aperture between the top of the central mounting aperture and the top of the central mounting tab, wherein the distance between the center of each pressure pin bonding site and the nearest portion of the bag mouth is about ¼ of an inch. In particular embodiments, the distance between the center of each pressure pin bonding site and the nearest portion of the bag mouth is ¼ of an inch.

In certain embodiments, the mounting apertures or handle mounting apertures are centered between the top and the bottom of the handles, while in other embodiments the mounting apertures are located closer to the top of the handles or closer to the bottom of the handles. The mounting apertures can be of various horizontal lengths along the handles, depending upon the size of the bag, including, but not limited to, about 1 inch, about 1.125 inches, about 1.25 inches, about 1.375 inches, about 1.5 inches, about 1.625 inches, about 1.75 inches, about 1.875 inches, about 2 inches, about 2.125 inches, about 2.25 inches, about 2.375 inches, or about 2.5 inches. In certain embodiments, the upper and lower ends of the mounting apertures are curved toward the outside edge of the handles, and the center of the mounting aperture is bowed toward the outside edge of the handles.

In particular embodiments, the central mounting tab is generally trapezoidal in shape, while in other embodiments the central mounting tab has the general shape of an isosceles trapezoid. The height of the central mounting aperture from the bottom of the bag mouth can be various distances, depending upon the size of the bag, including, but not limited to, about 0.5 inches, about 0.675 inches, about 0.75 inches, about 0.875 inches, about 1 inch, about 1.125 inches, about 1.25 inches, about 1.375 inches, about 1.5 inches, about 1.625 inches, about 1.75 inches, about 1.875 inches, about 2 inches, about 2.125 inches, about 2.25 inches, about 2.375 inches, or about 2.5 inches.

In certain embodiments, the central mounting aperture comprises a generally triangular-shaped or generally inverted “V” shaped opening. In particular embodiments, the top of the generally triangular-shaped opening, or the top of the inverted “V”-shaped opening, is positioned toward the top of the central mounting tab. The width of the central mounting aperture can vary, depending upon the size of the bag, including, but not limited to, about 0.5 inches, about 0.675 inches, about 0.75 inches, about 0.875 inches, about 1 inch, about 1.125 inches, about 1.25 inches, about 1.375 inches, about 1.5 inches, about 1.625 inches, about 1.75 inches, about 1.875 inches, about 2 inches, about 2.125 inches, about 2.25 inches, about 2.375 inches, or about 2.5 inches. The height of the central mounting aperture can vary, depending upon the size of the bag, including, but not limited to, about 0.25 inches, about 0.375 inches, about 0.5 inches, about 0.675 inches, about 0.75 inches, about 0.875 inches, about 1 inch, about 1.125 inches, about 1.25 inches, about 1.375 inches, about 1.5 inches, about 1.625 inches, about 1.75 inches, about 1.875 inches, or about 2 inches. In certain embodiments, the central mounting aperture has inward and upturned curved end portions.

In certain embodiments, the first and second pressure pin bonding regions each comprise at least four pressure pin bonding sites, at least five pressure pin bonding sites, at least six pressure pin bonding sites, at least seven pressure pin bonding sites, or at least eight pressure pin bonding sites. The first and second pressure pin bonding regions are generally located above and on opposite sides of the central mounting aperture, on opposite sides of the central severance aperture. In particular embodiments, the pressure pins are coated, for example with TEFLON®. In addition, the diameter of the pressure pins can vary, depending upon the size of the bag, from lengths including, but not limited to, about 0.25 inches, about 0.375 inches, about 0.5 inches, about 0.625 inches, to about 0.75 inches.

In certain embodiments, although the central severance aperture lies between the top of the central mounting aperture and the top of the central mounting tab, the central severance aperture does not contact the top of the central mounting aperture or the top of the central mounting tab. In other embodiments, the central severance aperture is centered between the top of the central mounting aperture and the top of the central mounting tab. The central severance aperture can be of various lengths, depending upon the size of the bag, including, but not limited to, about 0.0625 inches, about 0.09375 inches, about 0.125 inches, about 0.15625 inches, about 0.1875 inches, about 0.21875 inches, about 0.25 inches, about 0.28125 inches, about 0.3125 inches, about 0.34375 inches, or about 0.375 inches.

The present disclosure also provides a bag pack comprising a plurality of stacked bags, each bag comprising a front bag wall comprising a top portion, a bottom portion, and first and second sides, and a rear bag wall comprising a top portion, a bottom portion, and first and second sides, the rear bag wall and the front bag wall connected at the first sides of the rear bag wall and the front bag wall and the second sides of the rear bag wall and the front bag wall, sealed at the bottom portions of the rear bag wall and the front bag wall and at the top portions of the rear bag wall and the top bag wall, the top portions of the rear bag wall and the front bag wall comprising a pair of laterally spaced handles, the handles comprising integral extensions of the rear and front bag walls, each of the handles comprising a mounting aperture and a cold pin bonding site above the mounting aperture, the front wall and rear wall between the handles defining an open bag mouth, the handles extending above the bag mouth from a lower handle portion defining the lateral extent of a lower portion of the bag mouth to an upper handle portion defining a hand grip, a central mounting tab extending upwardly from the lower portion of the open bag mouth comprising a central mounting aperture and a first and a second pressure pin bonding region each comprising at least three pressure pin bonding sites, the first and second pin bonding regions generally above and on opposite sides of the central mounting aperture, and a central severance aperture between the top of the central mounting aperture and the top of the central mounting tab, wherein the distance between the center of the pressure pin bonding site and the nearest portion of the bag mouth is about ¼ of an inch. In certain embodiments, the bag pack comprises 5 bags, 10 bags, 15 bags, 20 bags, 25 bags, 30 bags, 35 bags, 40 bags, 45 bags, 50 bags, 55 bags, 60 bags, 65 bags, 70 bags, 75 bags, 77 bags, 80 bags, 85 bags, 90 bags, 95 bags, 100 bags, 125 bags, 150 bags, 175 bags, or 200 bags.

The present disclosure also provides a bag dispensing system comprising a bag pack comprising a plurality of stacked bags, each of the bags comprising a front bag wall comprising a top portion, a bottom portion, and first and second sides, and a rear bag wall comprising a top portion, a bottom portion, and first and second sides, the rear bag wall and the front bag wall connected at said first sides of the rear bag wall and the front bag wall and the second sides of the rear bag wall and the front bag wall, sealed at the bottom portions of the rear bag wall and the front bag wall and at the top portions of the rear bag wall and the top bag wall, the top portions of the rear bag wall and the front bag wall comprising a pair of laterally spaced handles, the handles comprising integral extensions of the rear and front bag walls, each of the handles comprising a mounting aperture and a cold pin bonding site above the mounting aperture, the front wall and rear wall between the handles defining an open bag mouth, the handles extending above the bag mouth from a lower handle portion defining the lateral extent of a lower portion of the bag mouth to an upper handle portion defining a hand grip, a central mounting tab extending upwardly from the lower portion of the open bag mouth comprising a central mounting aperture and a first and a second pressure pin bonding region each comprising at least three pressure pin bonding sites, the first and second pin bonding regions generally above and on opposite sides of the central mounting aperture, and a central severance aperture between the top of said central mounting aperture and the top of said central mounting tab, wherein the distance between the center of the pressure pin bonding site and the nearest portion of the bag mouth is about ¼ of an inch, and a rack for mounting the bag pack and loading and individually removing bags from the bag pack, the rack comprising a pair of laterally spaced elongated support rods having leading ends and a central, upwardly facing, support hook disposed between the support rods.

In certain embodiments of the bag dispensing system, the rack further comprises a pair of laterally spaced elongated side supports or brackets, which in some embodiments each comprise a pair of vertically spaced arms. In particular embodiments the side supports or brackets comprise at least a first upright support, at least a first and a second upright support, at least a first, a second, and a third upright support, or at least a first, a second, a third, and a fourth upright support, spanning the vertically spaced arms. In certain embodiments, the upright supports extend beyond the upper of the vertically spaced arms. In other embodiments, the rack comprises a pair of vertical members, wherein the support rods are attached near the top of the vertical members. In other embodiments, the side supports or brackets are attached to the vertical members below the support rods. In certain embodiments, the rack further comprises a base panel attached to the upright supports. The shape of the base panel can vary, such shapes including, but not limited to, generally square (with or without one or more of the corners cut off), generally rectangular (with or without one or more of the corners cut off), generally octagonal, generally circular, or generally oval. In particular embodiments, the upright supports are attached to the base panel near the rear of the base panel, while in other embodiments, the upright supports comprise a horizontal bend, and the end of the horizontal bend portion of the upright supports attach to the base panel on the sides of the base panel near the middle or front of the base panel. In certain embodiments, the rack further comprises a central transverse member attached to the vertical members below the side supports or brackets. In particular embodiments, the rack further comprises a lower transverse member attached to the vertical members below the side supports or brackets, or below the central transverse member. In certain embodiments, the lower transverse member extends beyond the vertical members, bends, and attaches to the rear of the base panel.

The present disclosure further provides a die for forming plastic handle bags, the die comprising a main blade having a bevel, the main blade formed generally in the shape of the letter “W”, a pair of handle aperture blades having bevels, one of the handle aperture blades positioned on either side of the outer arms of the main blade, pair of cold pins, one of the cold pins positioned above each of the handle aperture blades, a central aperture blade having a bevel, the central aperture blade positioned below the main blade, a central severance blade having a bevel, the central severance blade positioned between the central aperture blade and the main blade, and a plurality of pressure pins positioned generally between the central aperture blade and the main blade and on either side of the central severance blade, wherein the distance between the center of each of the pressure pins and the center of the bevel of the portion of the main blade closest to each of the pressure pins is about ¼ A of an inch. In certain embodiments, the pressure pins are coated, for example with TEFLON®. The bevel of the main blade, the handle aperture blades, and the central aperture blade can be the same, or can differ from each other, and generally are about 50°, about 55°, about 60°, about 65° or about 70°. The bevel of the central severance blade is generally about 40°, about 45°, about 50°, about 55°, about 60°, about 65°, or about 70°. The height of the blades about the face of the die can vary, depending upon the number of bags being cut, but is generally about 0.875 inches, about 0.90625 inches, about 0.9375 inches, about 0.96875 inches, about 1 inch, about 1.03125 inches, about 1.0625 inches, about 1.09375 inches, about 1.125 inches, about 1.15625 inches, about 1.1875 inches, about 1.21875 inches, or about 1.25 inches.

In general any size bag can be produced using the disclosed devices and methods. For example, small bags generally have a face width between about 4 inches and about 11 inches, and any size in-between, including, but not limited to, 4.25 inches, 4.5 inches, 4.75 inches, 5 inches, 5.25 inches, 5.5 inches, 5.75 inches, 6 inches, 6.25 inches, 6.5 inches, 6.75 inches, 7 inches, 7.25 inches, 7.5 inches, 7.75 inches, 8 inches, 8.25 inches, 8.5 inches, 8.75 inches, 9 inches, 9.25 inches, 9.5 inches, 9.75 inches, 10 inches, 10.25 inches, 10.5 inches, and 10.75 inches. Small bags also generally include a gusset range of between about 1 inch and about 8 inches, and any size in-between, including, but not limited to, 1.25 inches, 1.5 inches, 1.75 inches, 2 inches, 2.25 inches, 2.5 inches, 2.75 inches, 3 inches, 3.25 inches, 3.5 inches, 3.75 inches, 4 inches, 4.25 inches, 4.5 inches, 4.75 inches, 5 inches, 5.25 inches, 5.5 inches, 5.75 inches, 6 inches, 6.25 inches, 6.5 inches, 6.75 inches, 7 inches, 7.25 inches, 7.5 inches, and 7.75 inches. In general the cutoff or length range for small bags is between about 8 inches and about 16 inches, and any size in-between, including, but not limited to, 8.25 inches, 8.5 inches, 8.75 inches, 9 inches, 9.25 inches, 9.5 inches, 9.75 inches, 10 inches, 10.25 inches, 10.5 inches, 10.75 inches, 11 inches, 11.25 inches, 11.5 inches, 11.75 inches, 12 inches, 12.25 inches, 12.5 inches, 12.75 inches, 13 inches, 13.25 inches, 13.5 inches, 13.75 inches, 14 inches, 14.25 inches, 14.5 inches, 14.75 inches, 15 inches, 15.25 inches, 15.5 inches, and 15.75 inches.

Generally, medium bags have a face width between about 11 inches and about 25 inches, and any size in-between, including, but not limited to, 11.25 inches, 11.5 inches, 11.75 inches, 12 inches, 12.25 inches, 12.5 inches, 12.75 inches, 13 inches, 13.25 inches, 13.5 inches, 13.75 inches, 14 inches, 14.25 inches, 14.5 inches, 14.75 inches, 15 inches, 15.25 inches, 15.5 inches, 15.75 inches, 16 inches, 16.25 inches, 16.5 inches, 16.75 inches, 17 inches, 17.25 inches, 17.5 inches, 17.75 inches, 18 inches, 18.25 inches, 18.5 inches, 18.75 inches, 19 inches, 19.25 inches, 19.5 inches, 19.75 inches, 20 inches, 20.25 inches, 20.5 inches, 20.75 inches, 21 inches, 21.25 inches, 21.5 inches, 21.75 inches, 22 inches, 22.25 inches, 22.5 inches, 22.75 inches, 23 inches, 23.25 inches, 23.5 inches, 23.75 inches, 24 inches, 24.25 inches, 24.5 inches, and 24.75 inches. Medium bags also generally include a gusset range of between about 8 inches and about 12 inches, and any size in-between, including, but not limited to, 8.25 inches, 8.5 inches, 8.75 inches, 9 inches, 9.25 inches, 9.5 inches, 9.75 inches, 10 inches, 10.25 inches, 10.5 inches, 10.75 inches, 11 inches, 11.25 inches, 11.5 inches, and 11.75 inches. In general the cutoff or length range for medium bags is between about 16 inches and about 30 inches, and any size in-between, including, but not limited to, 16.25 inches, 16.5 inches, 16.75 inches, 17 inches, 17.25 inches, 17.5 inches, 17.75 inches, 18 inches, 18.25 inches, 18.5 inches, 18.75 inches, 19 inches, 19.25 inches, 19.5 inches, 19.75 inches, 20 inches, 20.25 inches, 20.5 inches, 20.75 inches, 21 inches, 21.25 inches, 21.5 inches, 21.75 inches, 22 inches, 22.25 inches, 22.5 inches, 22.75 inches, 23 inches, 23.25 inches, 23.5 inches, 23.75 inches, 24 inches, 24.25 inches, 24.5 inches, 24.75 inches, 25 inches, 25.25 inches, 25.5 inches, 25.75 inches, 26 inches, 26.25 inches, 26.5 inches, 26.75 inches, 27 inches, 27.25 inches, 27.5 inches, 27.75 inches, 28 inches, 28.25 inches, 28.5 inches, 28.75 inches, 29 inches, 29.25 inches, 29.5 inches, and 29.75 inches.

Generally, large bags have a face width between about 25 inches and about 40 inches, and any size in-between, including, but not limited to, 25.25 inches, 25.5 inches, 25.75 inches, 26 inches, 26.25 inches, 26.5 inches, 26.75 inches, 27 inches, 27.25 inches, 27.5 inches, 27.75 inches, 28 inches, 28.25 inches, 28.5 inches, 28.75 inches, 29 inches, 29.25 inches, 29.5 inches, 29.75 inches, 30 inches, 30.25 inches, 30.5 inches, 30.75 inches, 31 inches, 31.25 inches, 31.5 inches, 31.75 inches, 32 inches, 32.25 inches, 32.5 inches, 32.75 inches, 33 inches, 33.25 inches, 33.5 inches, 33.75 inches, 34 inches, 34.25 inches, 34.5 inches, 34.75 inches, 35 inches, 35.25 inches, 35.5 inches, 35.75 inches, 36 inches, 36.25 inches, 36.5 inches, 36.75 inches, 37 inches, 37.25 inches, 37.5 inches, 37.75 inches, 38 inches, 38.25 inches, 38.5 inches, 38.75 inches, 39 inches, 39.25 inches, and 39.75 inches. Large bags also generally include a gusset range of between about 12 inches and about 20 inches, and any size in-between, including, but not limited to, 12.25 inches, 12.5 inches, 12.75 inches, 13 inches, 13.25 inches, 13.5 inches, 13.75 inches, 14 inches, 14.25 inches, 14.5 inches, 14.75 inches, 15 inches, 15.25 inches, 15.5 inches, 15.75 inches, 16 inches, 16.25 inches, 16.5 inches, 16.75 inches, 17 inches, 17.25 inches, 17.5 inches, 17.75 inches, 18 inches, 18.25 inches, 18.5 inches, 18.75 inches, 19 inches, 19.25 inches, 19.5 inches, and 19.75 inches. In general the cutoff or length range for large bags is between about 30 inches and about 45 inches, and any size in-between, including, but not limited to, 30.25 inches, 30.5 inches, 30.75 inches, 31 inches, 31.25 inches, 31.5 inches, 31.75 inches, 32 inches, 32.25 inches, 32.5 inches, 32.75 inches, 33 inches, 33.25 inches, 33.5 inches, 33.75 inches, 34 inches, 34.25 inches, 34.5 inches, 34.75 inches, 35 inches, 35.25 inches, 35.5 inches, 35.75 inches, 36 inches, 36.25 inches, 36.5 inches, 36.75 inches, 37 inches, 37.25 inches, 37.5 inches, 37.75 inches, 38 inches, 38.25 inches, 38.5 inches, 38.75 inches, 39 inches, 39.25 inches, 39.5 inches, 39.75 inches, 40 inches, 40.25 inches, 40.5 inches, 40.75 inches, 41 inches, 41.25 inches, 41.5 inches, 41.75 inches, 42 inches, 42.25 inches, 42.5 inches, 42.75 inches, 43 inches, 43.25 inches, 43.5 inches, 43.75 inches, 44 inches, 44.25 inches, 44.5 inches, and 44.75 inches.

### BRIEF DESCRIPTION OF THE SEVERAL VIEWS OF THE DRAWINGS

For more complete understanding of the features and advantages of the present invention, reference is now made to the detailed description of the invention along with the accompanying figures.

FIG. 1. Front elevation view of an example of a bag formed in accordance with the present disclosure.

FIG. 2. Perspective view of an example of a bag pack formed in accordance with the present disclosure.

FIG. 3. Left side perspective view of an example of a bag dispensing rack in accordance with the present disclosure.

FIG. 4. Side view illustrating an example of a bag in accordance with the present disclosure removed from a bag dispensing rack in accordance with the present disclosure, and an example of a bag drawn forwardly from a bag pack in accordance with the present disclosure with the bag handles engaged with mounting rods in its mouth open loading position.

FIG. 5. Perspective view illustrating an example of a bag pack in accordance with the present disclosure mounted on a bag dispensing rack in accordance with the present disclosure with the bag handles engaged with a pair of mounting rods.

FIG. 6. Perspective view illustrating an example of a bag drawn forwardly from a bag pack in accordance with the present disclosure and maintained on the support rods in its mouth open loading position.

FIG. 7. Front elevation view of an example of a die in accordance with the present disclosure used to form bags and bag packs in accordance with the present disclosure.

FIG. 8. Side view of blade used to form central severance line between central mounting aperture blade and main blade in an example of a die in accordance with the present disclosure.

### DETAILED DESCRIPTION OF THE INVENTION

The present disclosure provides improved bags and bag packs that are easier to open and manipulate, and do not leave any scrap on a dispensing rack or the area around the dispensing rack. The present disclosure additionally provides bag cutting dies used to produce the improved bags and bag packs. The bags, bag packs, bag dispensing racks and systems, and bag cutting dies are discussed in greater detail in the following paragraphs.

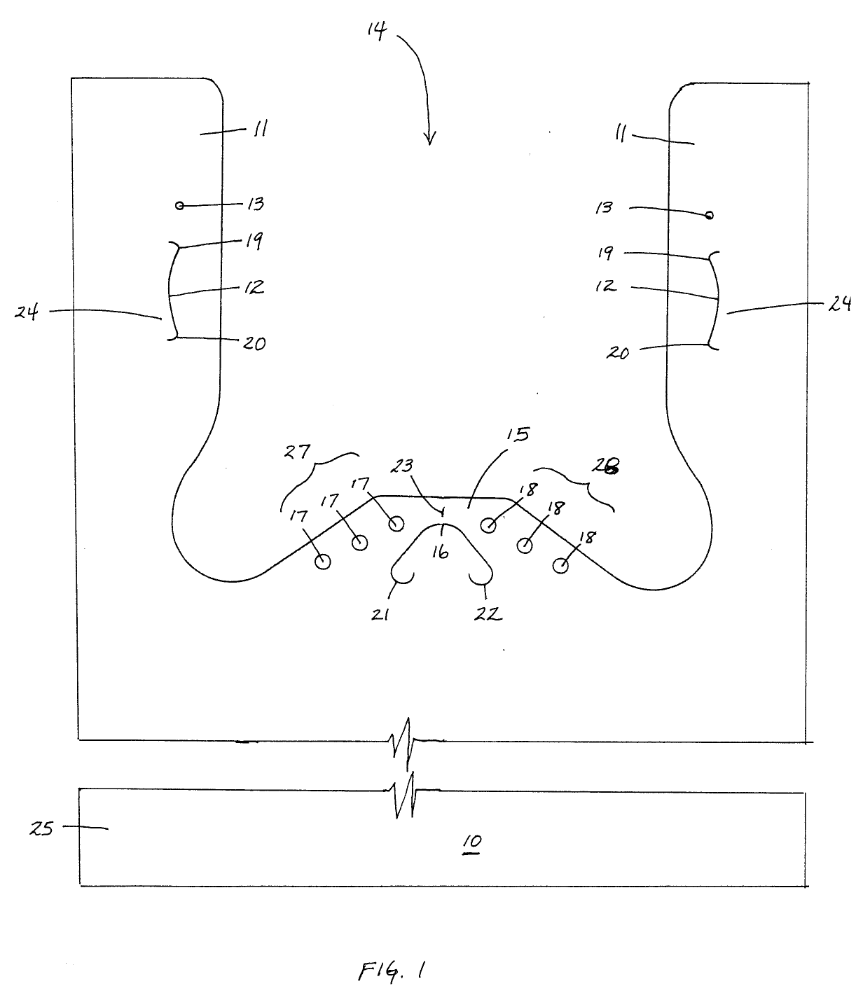

As an example of the bags of the present disclosure, bag 10 is shown in FIG. 1. The mouth 14 of the bag 10 is formed by a cutout inwardly and centrally through the upper portion of the bag. This cutout defines the central mounting tab 15 and a pair of laterally spaced upwardly extending handles 11 formed of upwardly extending portions of the front 25 and rear (not shown) panels of the bag 10 respectively, as well as similarly upwardly extending portions of the side gussets (not shown). The lower portions of the bag handles define the lateral extent of the bag mouth and upper portions of the bag handles define a hand grip for the bags. Such bag construction, as thus far described, is generally known in the art as will be appreciated from U.S. Pat. No. 4,529,090.

Each bag handle 11 also includes a mounting aperture 12 formed by elongated generally vertical slots or openings extending longitudinally of the bag handles. The mounting aperture 12 terminates in top and bottom curved portions 19 and 20, respectively, which serve to distribute and relieve stresses imposed on the mounting slots. Each bag handle 11 also defines a cold pin or nail hole 13 above the mounting aperture 12, which is penetrated by a cold pin, nail or other sharp round metal object on the die to assist in collecting and aligning individual bags as they are being formed into a pack. The mounting apertures 12 preferably are disposed near the center of the bag handles 11. Flaps 24 are formed of handle material as the mounting apertures 12 and curved ends 19 and 20 are formed by a knife or razor cut.

A further feature of the bag in accordance with the present disclosure involves a central mounting tab 15 comprising a curved central mounting aperture 16, with inwardly and upwardly facing curved end portions 21 and 22 in the lower portion of, or just below, the central mounting tab 15. A central severance aperture 23 extends partially between the center portion of the central mounting aperture 16 and the top of the central mounting tab 15. The central mounting tab also comprises a first and a second pressure pin bonding region 27 and 28, respectively. Each pressure pin bonding region comprises at least three, and in certain aspects four, five, six, or more pressure pin bonding sites, in this example shown as three pressure pin bonding sites 17 in first pressure pin bonding region 27, and three pressure pin bonding sites 18 in second pressure pin bonding region 28. The first and second pressure pin bonding regions 27 and 28 are generally disposed above and on either side of central mounting aperture 16, and thus on either side of the central severance aperture 23.

The bag 10 is preferably of a lightweight, highly flexible, heat sealable, tough and high mechanical strength thermoplastic material, including, but not limited to, low, linear low, medium, high density polyethylene and mixtures thereof. In addition, biodegradable or oxodegradable materials, recyclable materials, and materials such as polypropylene, a copolymer of ethylene and another alpha-olefin can also be employed as the film materials. The bag 10 is conventionally fabricated from a continuous plastic tube gusseted, flattened and heat sealed at opposed upper and lower ends.

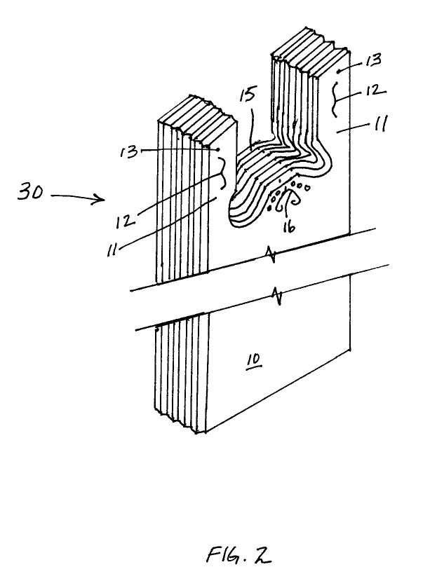

Referring to FIG. 2, the present disclosure also provides for a pack 30 of the bags 10. In order to form the bag packs 30, a desired quantity of individual bags 10 are disposed in overlapping arrangement and cold pins, nails, other sharp round metal objects or the like are inserted through the overlying bags, deforming or swaging the bag material in the immediate vicinity of the cold pin or nail holes 13 so as to releaseably bond the individual bags together into a unitary pack. The bond thus created is only sufficient to hold the bags together as they are handled and placed on the dispensing racks. The deformed or swaged portions attaching the individual bags to each other are easily separated as the individual bags are dispensed from the racks. Any desired number of such cold pin hole sites may be provided. In the example shown, two cold pin bonding sites 13 are provided in the handle portions 11, one above each of the mounting apertures 12. Although any number of bags may be used to form a bag pack, typical bag packs include 50, 77, or 100 bags.

The pressure pin bonding sites 17 and 18 in the central mounting tab 15 also provide a self-opening feature for the bags 10. As the front wall 25 of the bag 10 is pulled forward to open the bag for filling, the attachment between the front and back portions of the central mounting tabs 15 will be severed, but the attachment between the back portion of the central mounting tab 15 and the next bag in the bag pack generally will not be severed. As the filled bag then is lifted from the support arms 42, the back portion of the mounting tab 15 will be pulled forward, tending to open the mounting tab 15 of the next following bag before the connection between the two bags is broken.

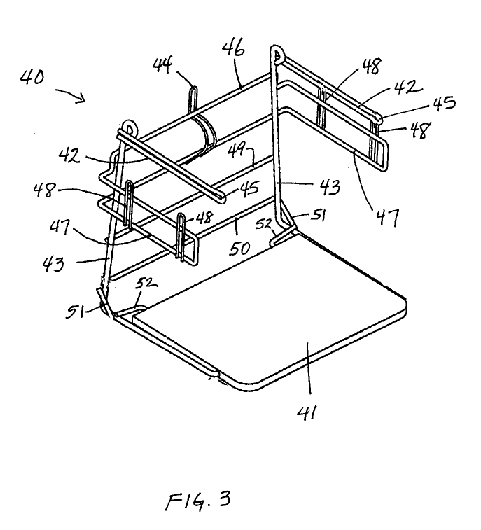

Referring to FIG. 3, the present disclosure also provides a support rack 40 for the mounting of a pack 30 of bags 10 for both the selective dispensing of the individual bags by the handles and with the open mouth upwardly directed for a loading of the bag. The rack 40 will generally include a flat base or support panel 41 and a pair of laterally spaced support arms 42 positioned vertically above the base panel 41 a distance sufficient to accommodate a fully expanded bag 10 with the handles 11 engaged with the support arms 42 and the bottom of the bag 10 on the base panel 41. The support arms 42 are joined near the upper end of vertical member 43, while the lower end of vertical member 43 curves about 90° and is affixed on the side of base panel 41 toward the front end of base panel 41. An upper transverse member 46 extends between the support arms 42 and supports a tab receiving hook element 44 for engagement through the central aperture 16 formed in or below the central mounting tab 15 of the bags 10, as described herein. The upper transverse member 46 also curves around the support arms 42 to form side supports 47 for the pack 30. Also shown in this example are optional upright supports 48 and middle transverse member 49, which also extends between the support arms 42. Lower transverse member 50 extends between support arms 42, and can optionally extend around support arms 42 and affix into rear of base panel 41. The portion of lower transverse member 50 that extends around support arms 42 can optionally comprise two separate members 51 and 52, both of which are affixed to support arms 42 and one of which is affixed into rear of base panel 41. The support arms 42 and transverse members 46, 49 and 50 may be rigidly joined to vertical member 43. The bag pack 30 will normally be accommodated generally rearward on the rack 40 toward the upright, or vertical member 43, allowing for the forward extent of the support panel 41 and overlying support rods 42 to accommodate an opened bag for loading purposes. The rack 40 will also normally include upturned forward ends 45 on the laterally spaced horizontal support rods 42, for preventing accidental forward displacement of the bag handles 11 off of the forward ends of the support rods 42.

It will be appreciated by the skilled artisan that the presently disclosed support rack 40 can have a variety of configurations, such as different heights for the vertical member 43, different spacing widths of the support arms 42 and support panel 41, different numbers of transverse supports, and the like. In addition, while the support panel 41 is shown as a generally rectangular shape, other shapes of support panels will also find use in the presently disclosed support racks, including, but not limited to, square, octagonal, or rectangular with the front corners removed.

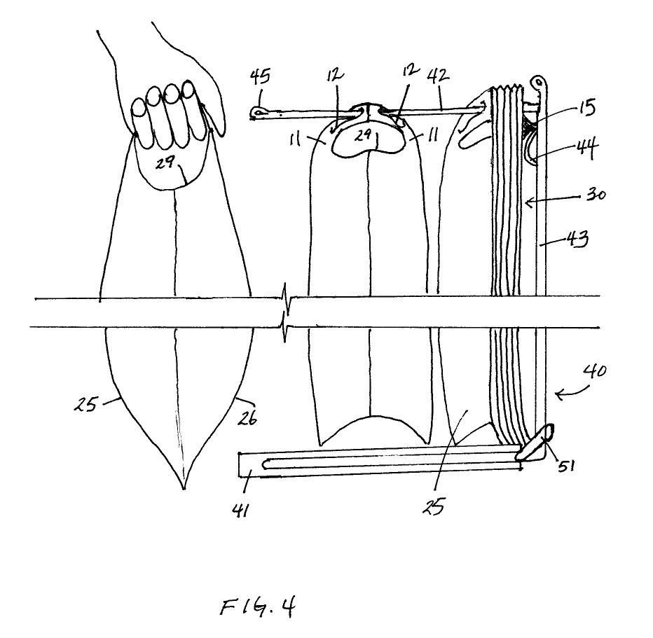

As shown in FIG. 4, it is specifically intended that the bag pack 30 be suspended from the support rods 42 by handles 11 by passing through mounting apertures 12 and from the central mounting tabs 15 by passing the hook 44 through the central mounting aperture (not visible) in a manner whereby each individual bag 10, as it is moved forward from the pack 30, is retained in an upright open position by the handle engaged support rods 42, for a loading thereof prior to removal from the rack 40, and also pulls the front panel 25 of the next bag 10 in the bag pack 30 to a half-open position. As bag 10 is opened, side gusset 29 becomes visible. Accordingly, specific provision is made in the present disclosure for the engagement of the bag handles 11 with the support rods 42. In alternative embodiments, the central mounting aperture may be engageable with other hook designs of prior art bag rack structures. Note that in FIG. 4 the side supports 47 of the upper transverse member 46 and middle transverse member 49 of rack 40 are not shown for ease of representation of side view of bag pack 30, open bag 10, and the front panel 25 of the following half-open bag 10.

The engagement of the bag handles 11 is achieved by the provision of rod receiving mounting apertures 12, one through each bag handle 11. The mounting apertures 12 are formed by elongated generally vertical slots or openings extending longitudinally of the bag handles 11. As detailed above, the vertical apertures or slots 12 terminate in bottom and top curved portions 19 and 20, respectively, which serve to distribute and relieve stresses imposed on the mounting apertures or slots 12. As explained below, the elongated mounting apertures or slots 12 make it possible to open the bag mouth to its full desired extent. In certain embodiments, the bag 10 is opened without having a substantial length of bag handle 11 above the top of the mounting apertures or slots 12. In such embodiments, the vertical mounting apertures 12 preferably have their top curved portions 19 disposed near the upper termination of the bag handles 11. In particular embodiments, the distance between the top of the top curved portions 19 and the top of the bag handle 11 is about the length of the vertical mounting apertures or slots 12.

As detailed above, flaps 24 are formed of handle material as the vertical mounting apertures or slots 12 and curved ends 19 and 20 are formed by a knife or razor cut, and preferably are left in place. The flaps 24 are displaced from the bag pack as the bag pack is inserted on the mounting arms 42 of the rack 40 and help to provide frictional engagement between the mounting arms 42 and the bag pack 30 to keep the bag pack 30 disposed on the rearward portion of the mounting arms 42 as individual bags 10 are pulled forward for opening and use.

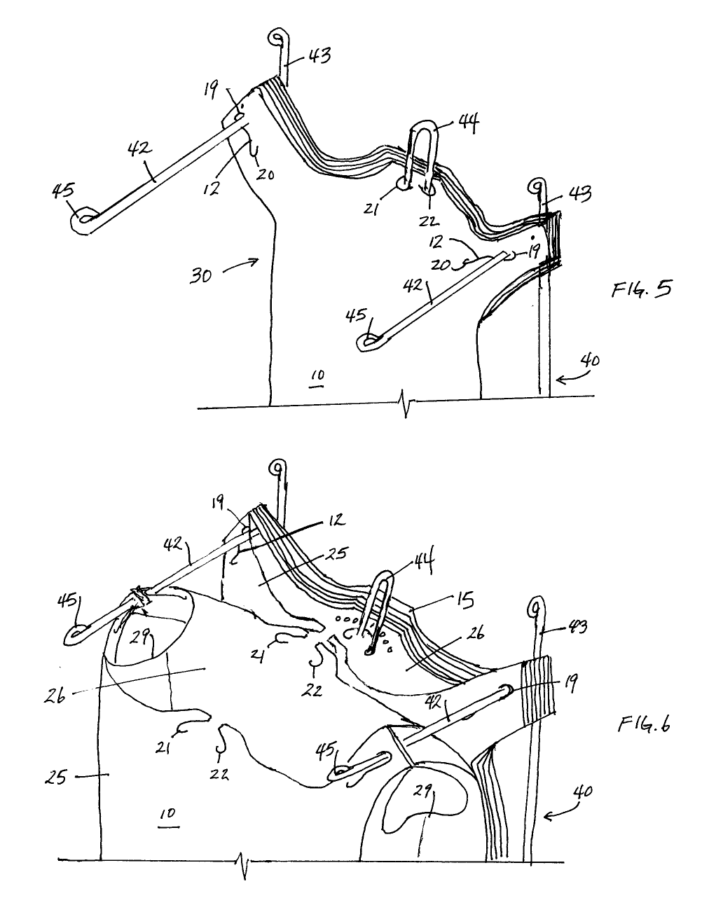

As shown in FIG. 5, when the bag pack 30 is placed on the mounting rack 40 the parallel supporting arms 42 will be received in the upper curved portions 19 of the mounting apertures or slots 12. As an individual bag 10 is pulled forward on the mounting arms 42, and disposed in a mouth open position for loading, the upper curved portions 19 of the mounting slots 12 will remain resting on the support rods 42. As shown in FIG. 6, as the bag 10 is opened, the remainder of the mounting slot 12 may be disposed generally longitudinally of the mounting rods 42 to permit maximum opening of the bag mouth area. This construction makes it possible in certain embodiments to shorten the overall length of the handles 11, and thus the overall length of the bags 10, without sacrificing either storage capacity of the bag or the size of the mouth opening during filling operations.

As individual bags 10 from the bag pack 30 are pulled forwardly on the support arms 42, the central severance aperture will tear apart, releasing the central tabs 15 from the support hook 44. In addition, as the bag 10 is opened, the front panel 25 of the following bag 10 in the pack 30 is pulled to a half-open position on the rack 40, tearing the central severance aperture and releasing the central tab of the front panel from the support hook 44, while the central tab 15 of the back panel 26 of the bag 10 remains on support hook 44, and the back panel 26 of the bag 10 stays with the remainder of the pack 30. However, all portions of the mounting tabs 15 remain attached to the bag 10 and are removed with the bag, leaving no portions of the mounting tab on the support rack 40, or loose to fall away from the bag 10. The central curved portion of the central mounting aperture 16 helps center the mounting tabs 15 on the hook 44 and also concentrates forces as the bottom of the central severance aperture 23, thus assuring that severance will occur at the central severance aperture 23 rather than elsewhere in the tab area. The inwardly upturned end portions 21 and 22 of the central mounting aperture 16 reduce force concentrations and avoid accidental downward or side tears of the bag body material.

Use of the elongated mounting apertures or slots 12 also makes the bag packs 30 extremely versatile. Since the mounting apertures 12 are relatively large in size, and extend over a substantial vertical length, they allow one bag construction to be used with various heights and designs of mounting racks 40. For example, a single bag pack 30 formed in accordance with the present disclosure may be used on a mounting rack 40 with the support arms 42 at varying heights and horizontal spacing, with signal or double support arms and with support arms of various diameters. Bags of varying capacity also may be used on a single mounting rack 40 having a single pair of support arms 42. This permits bag packs 30 in accordance with the present disclosure to be used on a wide variety of bag racks 40, including for example those already in place in many retail outlets and supermarkets.

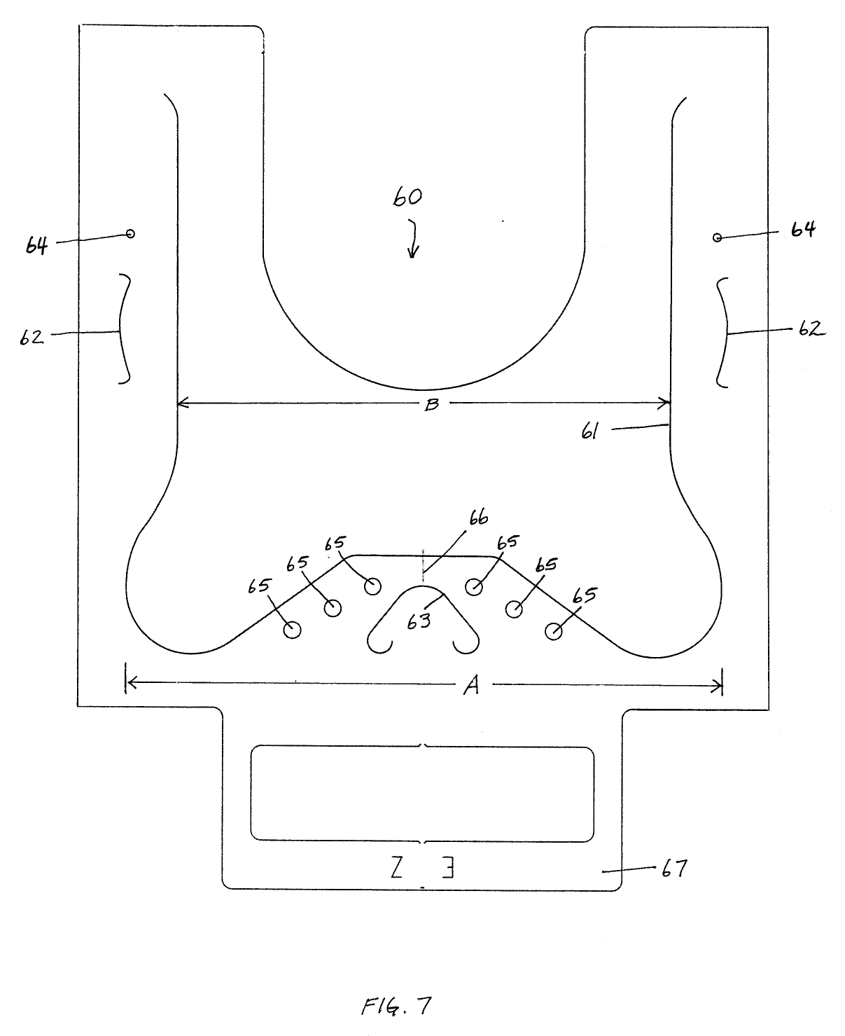

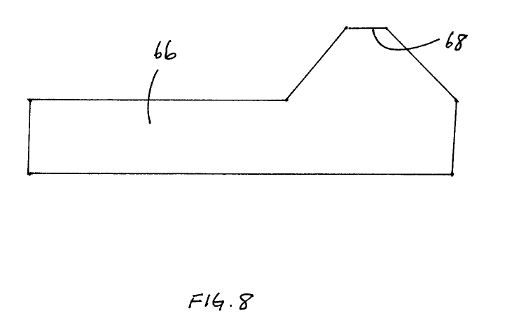

Shown in FIG. 7 is an example of a die 60 used to manufacture the bags of the present disclosure. The die 60 includes main blade 61, positioned in the approximate shape of the letter “W”, with the two outer arms of the “W” much longer than the central raised portion of the “W”, and the central raised portion of the “W” is generally in the shape of a trapezoid. The distance B between the two outer arms of the main blade can be a variety of different distances, depending upon the size of the bags being produced, although a common distance is 5.75 inches. In addition, the distance A, which represents the maximum horizontal width of the bag mouth, can also be a variety of different distances, depending upon the size of the bags being produced, although a common distance is 6.5 inches. The main blade forms the mouth 14 and handles 11 of the bag 10, side mounting aperture blades 62, and central mounting aperture blade 63. A variety of blades can be used on the dies of the present disclosure, for example universal 60 blades, which include a 60° bevel. However, other blades can be used in other embodiments of the present disclosure. In various embodiments, for example for different sizes or thicknesses of bags, the blade can extend above the die different distances, although a common height is 0.937 of an inch.

The die 60 also includes central severance line blade 66, cold pins 64, and central mounting tab pressure pins 65. In certain embodiments, the pressure pins are coated, for example with TEFLON®. While the size of the pressure pins can vary, for example from ¼ of an inch, ⅜ of an inch, or ⅝ of an inch, depending upon the size of the bag, the inventor has discovered that by using a ¼ inch distance between the center of the pressure pin and the center on the bevel on the main blade, and TEFLON® coating on the pressure pins, the bags are easier to open and manipulate. The result is that when the first bag in a bag pack is pulled open to load the bag, the front panel of the following bag in the bag pack is pulled to a half-open position. Also shown in FIG. 7 is handle 67.

Shown in FIG. 8 is the detail of the central severance line blade 66. While the central severance line blade 66 when viewed from above the face of the die 60 (see FIG. 7) appears to span the entire distance between the central mounting aperture blade 63 and the main blade 61, the upper portion 68 of the central severance aperture blade 66, which is the only portion of the blade that makes contact with the bag 10, is generally centered between the central mounting aperture blade 63 and the main blade 61. The length of the upper portion of the central severance line blade can vary depending on the size of the bag, but in general is between 3/32 of an inch and ⅜ of an inch in length. However, other lengths, including, but not limited to, ⅛ of an inch, 5/32 of an inch, 3/16 of an inch, 7/32 of an inch, ¼ of an inch, 9/32 of an inch, 5/16 of an inch, or 11/32 of an inch, can be used in other embodiments of the present disclosure. In addition, while the main blade 61 generally has a bevel of about 60°, the upper portion 68 of the central severance aperture blade 66 can generally has a 45° or 60° bevel.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

What is claimed:

1. A bag comprising:
a) a front bag wall comprising a top portion, a bottom portion, and first and second sides; and
b) a rear bag wall comprising a top portion, a bottom portion, and first and second sides; said rear bag wall and said front bag wall connected at said first sides of said rear bag wall and said front bag wall and said second sides of said rear bag wall and said front bag wall, sealed at said bottom portions of said rear bag wall and said front bag wall and at said top portions of said rear bag wall and said top bag wall, said top portions of said rear bag wall and said front bag wall comprising a pair of laterally spaced handles, said handles comprising integral extensions of said rear and front bag walls; each of said handles comprising a mounting aperture and a cold pin bonding site above said mounting aperture, said front wall and rear wall between said handles defining an open bag mouth, said handles extending above said bag mouth from a lower handle portion defining the lateral extent of a lower portion of said bag mouth to an upper handle portion defining a hand grip, a central mounting tab extending upwardly from said lower portion of said open bag mouth comprising a central mounting aperture and a first and a second pressure pin bonding region each comprising at least three pressure pin bonding sites, said first and second pin bonding regions generally above and on opposite sides of said central mounting aperture, and a central severance aperture between the top of said central mounting aperture and the top of said central mounting tab, wherein the distance between the center of each pressure pin bonding site and the nearest portion of the bag mouth is about ¼ of an inch.

2. The bag of claim 1, wherein the distance between the center of each pressure pin bonding site and the nearest portion of the bag mouth is ¼ of an inch.

3. The bag of claim 1, wherein said central mounting aperture comprises a triangular-shaped opening.

4. The bag of claim 3, wherein the top of said triangular-shaped opening is pointed at the top of said central mounting tab.

5. The bag of claim 3, wherein said central mounting aperture has upturned curved end portions.

6. The bag of claim 1, wherein said central severance aperture does not contact the top of said central mounting aperture or the top of said central mounting tab.

7. The bag of claim 1, wherein said central severance aperture is centered between the top of said central mounting aperture and the top of said central mounting tab.

8. A bag pack comprising a plurality of stacked bags, each bag comprising:
a) a front bag wall comprising a top portion, a bottom portion, and first and second sides; and
b) a rear bag wall comprising a top portion, a bottom portion, and first and second sides; said rear bag wall and said front bag wall connected at said first sides of said rear bag wall and said front bag wall and said second sides of said rear bag wall and said front bag wall, sealed at said bottom portions of said rear bag wall and said front bag wall and at said top portions of said rear bag wall and said top bag wall, said top portions of said rear bag wall and said front bag wall comprising a pair of laterally spaced handles, said handles comprising integral extensions of said rear and front bag walls; each of said handles comprising a mounting aperture and a cold pin bonding site above said mounting aperture, said front wall and rear wall between said handles defining an open bag mouth, said handles extending above said bag mouth from a lower handle portion defining the lateral extent of a lower portion of said bag mouth to an upper handle portion defining a hand grip, a central mounting tab extending upwardly from said lower portion of said open bag mouth comprising a central mounting aperture and a first and a second pressure pin bonding region each comprising at least three pressure pin bonding sites, said first and second pin bonding regions generally above and on opposite sides of said central mounting aperture, and a central severance aperture between the top of said central mounting aperture and the top of said central mounting tab, wherein the distance between the center of the pressure pin bonding site and the nearest portion of the bag mouth is about ¼ of an inch.

9. The bag pack of claim 8, wherein the distance between the center of each pressure pin bonding site and the nearest portion of the bag mouth of each bag is ¼ of an inch.

10. The bag pack of claim 8, wherein said central severance aperture of each bag is centered between the top of said central mounting aperture and the top of said central mounting tab.

11. The bag pack of claim 8, wherein said bag pack comprises 50, 77, or 100 bags.

12. A bag dispensing system comprising:
a) a bag pack comprising a plurality of stacked bags, each of said bags comprising:
i) a front bag wall comprising a top portion, a bottom portion, and first and second sides; and
ii) a rear bag wall comprising a top portion, a bottom portion, and first and second sides; said rear bag wall and said front bag wall connected at said first sides of said rear bag wall and said front bag wall and said second sides of said rear bag wall and said front bag wall, sealed at said bottom portions of said rear bag wall and said front bag wall and at said top portions of said rear bag wall and said top bag wall, said top portions of said rear bag wall and said front bag wall comprising a pair of laterally spaced handles, said handles comprising integral extensions of said rear and front bag walls; each of said handles comprising a mounting aperture and a cold pin bonding site above said mounting aperture, said front wall and rear wall between said handles defining an open bag mouth, said handles extending above said bag mouth from a lower handle portion defining the lateral extent of a lower portion of said bag mouth to an upper handle portion defining a hand grip, a central mounting tab extending upwardly from said lower portion of said open bag mouth comprising a central mounting aperture and a first and a second pressure pin bonding region each comprising at least three pressure pin bonding sites, said first and second pin bonding regions generally above and on opposite sides of said central mounting aperture, and a central severance aperture between the top of said central mounting aperture and the top of said central mounting tab, wherein the distance between the center of the pressure pin bonding site and the nearest portion of the bag mouth is about ¼ of an inch; and
b) a rack for mounting said bag pack and loading and individually removing bags from said bag pack, said rack comprising a pair of laterally spaced elongated support rods having leading ends and a central, upwardly facing, support hook disposed between said support rods.

13. The bag dispensing system of claim 12, wherein the distance between the center of each pressure pin bonding site and the nearest portion of the bag mouth of each bag is ¼ of an inch.

14. The bag dispensing system of claim 12, wherein said central severance aperture of each bag is centered between the top of said central mounting aperture and the top of said central mounting tab.

15. A die for forming plastic handle bags, said die comprising:
a) a main blade having a bevel, formed generally in the shape of the letter “W”;
b) a pair of handle aperture blades, one of said handle aperture blades positioned on either side of the outer arms of the main blade;
c) a pair of cold pins, one of said cold pins positioned above each of said handle aperture blades;
d) a central aperture blade positioned below said main blade;
e) a central severance blade having a bevel, positioned between said central aperture blade and said main blade; and
a plurality of pressure pins positioned generally between said central aperture blade and said main blade and on either side of said central severance blade,
wherein the distance between the center of said pressure pins and the center of the bevel of the portion of the main blade closest to said pressure pins is about ¼ of an inch.

16. The die of claim 15, wherein said pressure pins are coated.

17. The die of claim 16, wherein said pressure pins are coated with Teflon.

18. The die of claim 15, wherein said main blade has a bevel of 60°.

19. The die of claim 15, wherein said central severance blade has a bevel of 45°.

20. The die of claim 15, wherein said central severance blade has a bevel of 60°.
